(19) United States
(12) Patent Application Publication
(10) Pub. No.: US 2021/0157479 A1
(43) Pub. Date: May 27, 2021

(54) EXTENDED CONTROL DEVICE AND IMAGE CONTROL METHOD

(71) Applicant: PEGATRON CORPORATION, Taipei (TW)

(72) Inventor: Kuo-Hsuan Li, Taipei (TW)

(21) Appl. No.: 17/088,716

(22) Filed: Nov. 4, 2020

(30) Foreign Application Priority Data
Nov. 26, 2019 (TW) 108143028

(51) Int. Cl. G06F 3/0488; G06F 3/023; G06F 3/14; G06T 7/246; G06F 3/01; G01S 15/08; A63F 13/2145

(52) U.S. Cl. CPC G06F 3/04886; G06F 3/023; G06F 3/1423; A63F 13/2145; G06F 3/011; G01S 15/08; G06T 7/246

(57) ABSTRACT

Disclosed is an extended control device, suitable for cooperating with an electronic device, where the electronic device is provided with a graphical user interface. The extended control device includes a communication module for receiving image signals and sending input signals, and a plurality of input display modules. The input display modules each include an input unit for generating an input signal in response to an input operation, and a display unit for display according to an image signal. The electronic device generates first image signals according to images in operating regions of the graphical user interface so that the images in the operating regions are respectively mapped to the display units of the input display modules for display. The corresponding operating regions in the graphical user interface execute a corresponding operation instruction according to the input signals.

### CROSS-REFERENCE TO RELATED APPLICATION

This application claims the priority benefit of Taiwan application serial no. 108143028, filed on Nov. 26, 2019. The entirety of the above-mentioned patent application is hereby incorporated by reference herein and made a part of this specification.

### BACKGROUND

### Technical Field

The application relates to an extended device, and in particular, to an extended control device and an image control method.

### Related Art

Existing electronic games are generally controlled by a user through input interfaces such as a joystick, a key, a keyboard, and a mouse. Such input interfaces are not intuitive. A user needs to practice to be familiar with the input interfaces, and even needs to memorize functions of each key to play normally.

### SUMMARY

In view of this, an embodiment of the application provides an extended control device, suitable for cooperating with an electronic device. The electronic device is provided with a graphical user interface, where the graphical user interface includes a plurality of operating regions.

The extended control device includes a communication module and a plurality of input display modules. The communication module communicates with the electronic device to receive a plurality of first image signals generated according to images in the operating regions of the graphical user interface. Each of the input display modules includes an input unit and a display unit, where the input units generate a plurality of first input signals respectively in response to an input operation; the plurality of first input signals are transmitted to the electronic device through the communication module; the operating regions of the graphical user interface execute corresponding operation instructions correspondingly according to the first input signals; and the images in the operating regions are mapped to the display units for display according to the first image signals. As a result, a user may perform operations and interaction on the input display modules of the extended control device.

An embodiment of the application further provides an image control method, including: displaying an image in each of a plurality of operating regions of a graphical user interface of an electronic device respectively; generating, by the electronic device, a plurality of first image signals according to the images; outputting, by the electronic device, the first image signals to an extended control device so that the images in the operating regions are respectively mapped to a plurality of display units of the extended control device for display; generating, by the extended control device, a plurality of first input signals respectively in response to an input operation; and receiving, by the electronic device, the first input signals from the extended control device so that the operating regions of the graphical user interface execute operation instructions correspondingly.

In some embodiments, the input unit includes a touch panel corresponding to a display surface setting of the display unit, and the input operation is a touch operation.

In some embodiments, the input unit is a switch and the input operation is a keystroke operation.

In some embodiments, the graphical user interface further includes a plurality of interactive regions and the electronic device generates second image signals according to images in the plurality of interactive regions. The extended control device further includes a touchscreen, where the touchscreen is divided into a plurality of mapping regions and generates a plurality of second input signals in response to touch operations respectively corresponding to the mapping regions. The electronic device outputs the second image signals to the extended control device so that the extended control device respectively maps the images in the interactive regions to the plurality of mapping regions of the touchscreen of the extended control device for display according to the second image signals. The electronic device receives the second input signals so that the interactive regions of the graphical user interface execute interactive instructions correspondingly.

In some embodiments, the extended control device further includes a processor, where the processor is connected between the communication module and the touchscreen.

In some embodiments, the extended control device further includes a plurality of processors, where one end of each of the processors is connected to the communication module, and another end of each of the processors is connected to each of the input display modules in a one-to-one manner to control the input units and the display units of the connected input display modules.

In some embodiments, the extended control device further includes a 3D motion detection module and a processor. The 3D motion detection module includes a plane sensing unit and a distance sensing unit. The plane sensing unit is configured to sense a plane coordinate displacement of a dynamic object. The distance sensing unit is configured to sense a vertical distance relative to the dynamic object. The processor calculates a plane movement distance of the dynamic object according to the vertical distance and the plane coordinate displacement, and obtains 3D movement information of the dynamic object with reference to a change in the vertical distance of the dynamic object.

In some embodiments, the plane sensing unit includes an infrared sensor and an image sensor. The infrared sensor is configured to detect the presence of the dynamic object. The image sensor is configured to capture a plurality of sequential images of the dynamic object. The processor recognizes a feature corresponding to the dynamic object in the sequential images, and obtains the plane coordinate displacement according to a displacement of the feature.

In some embodiments, the distance sensing unit includes a sonar sensor and a proximity sensor. The sonar sensor is configured to sense a spacing distance relative to the dynamic object. The proximity sensor includes an effective detection range for determining that the dynamic object exists in the effective detection range. The processor obtains the vertical distance according to the spacing distance when the dynamic object exists in the effective detection range.

In some embodiments, the extended control device further includes a peripheral device, where the peripheral device is a microphone, a joystick, a key, a touchpad, a vibration motor or a light.

To sum up, compared with the existing electronic device, embodiments of the application provide diverse and intuitive operations to improve use experience and reduce operation difficulty for a user. Furthermore, each of a plurality of processors is used for managing a part of hardware respectively, so that lower-level processors may be selected, thereby reducing costs and energy consumption.

### BRIEF DESCRIPTION OF THE DRAWINGS

FIG. 1 is a schematic structural diagram of an extended control device according to a first embodiment of the application;

FIG. 2 is a circuit block diagram of an extended control device according to the first embodiment of the application;

FIG. 3 is a schematic flowchart of an image control method according to the first embodiment of the application;

FIG. 4 is a schematic structural diagram of an extended control device according to a second embodiment of the application;

FIG. 5 is a circuit block diagram of an extended control device according to the second embodiment of the application;

FIG. 6 is a schematic flowchart of an image control method according to the second embodiment of the application;

FIG. 7 is a schematic structural diagram of an extended control device according to a third embodiment of the application;

FIG. 8 is a circuit block diagram of an extended control device according to the third embodiment of the application;

FIG. 9 is a schematic diagram of a measurement of a 3D motion detection module according to the third embodiment of the application; and

FIG. 10 is a schematic flowchart of 3D motion detection according to the third embodiment of the application.

### DETAILED DESCRIPTION

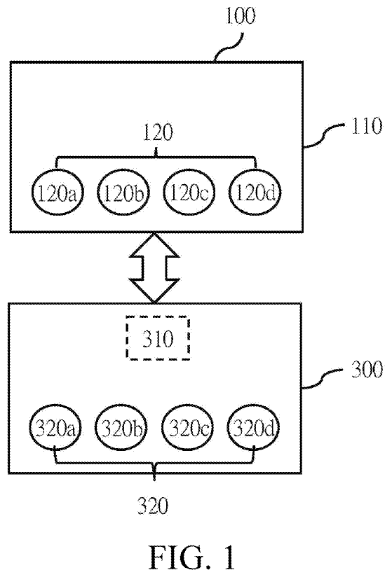

Referring to FIG. 1, FIG. 1 is a schematic structural diagram of an extended control device 300 according to a first embodiment of the application. The extended control device 300 is suitable for cooperating with an electronic device 100 to provide a user with an operation interface for controlling the electronic device 100. The electronic device 100 may be a computing device with software execution capabilities, such as a desktop computer, a notebook computer, a tablet computer, and a mobile phone, and is provided with hardware such as a processor, a memory, and storage media, and may also include other required hardware. For example, the electronic device 100 may include a network interface in the case that network resources are required. The electronic device 100 executes an application including but not limited to game software, and is provided with a graphical user interface 110. The graphical user interface 110 includes a plurality of operating regions 120. Four operating regions 120a to 120d are taken as an example herein.

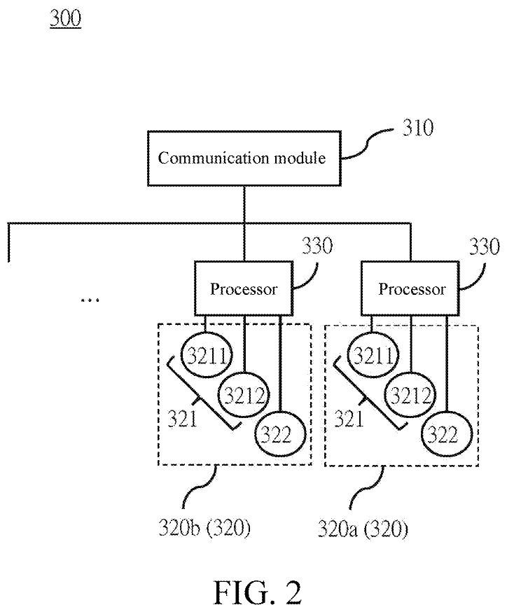

Referring to FIG. 1 and FIG. 2 together, FIG. 2 is a circuit block diagram of the extended control device 300 according to the first embodiment of the application. The extended control device 300 includes a communication module 310 and a plurality of input display modules 320. Four input display modules 320a to 320d are taken as an example herein. The communication module 310 is communicatively connected to the electronic device 100 to perform signal transmission with the electronic device 100. The communication module 310 supports wired transmission interfaces such as a Universal Serial Bus (USB), or supports wireless transmission interfaces such as Bluetooth or Wi-Fi.

In some embodiments, the extended control device 300 further includes a plurality of processors 330 connected between the communication module 310 and the plurality of input display modules 320 to control the input display modules 320. Furthermore, one end of each of the processors 330 is connected to the communication module 310, and another end of each of the processors 330 is connected to each of the input display modules 320 in a one-to-one manner. Therefore, compared with a case in which only a single computing unit is used, computing resources are provided by a plurality of processors 330 together, so that hardware with low computing resources and a simple connection interface may be used.

In some embodiments, the quantity of the processors 330 may be less than that of the input display modules 320. That is, some of or all the processors 330 may be connected to a plurality of input display modules 320.

A single input display module 320 includes an input unit 321 and a display unit 322. The input unit 321 is provided to allow a user to perform an input operation and generates an input signal (hereinafter referred to as a “first input signal”) in response to the input operation. In some embodiments, the input display module 320 is in the form of a key capable of receiving the input operation, which is a keystroke operation, of the user. The input unit 321 includes a switch 3211 to detect the keystroke operation. In some embodiments, the input unit 321 includes a touch panel 3212 capable of receiving the input operation, which is a touch operation, of the user. Here, the touch panel 3212 is disposed corresponding to a display surface of the display unit 322, that is, a touch area of the touch panel 3212 substantially overlaps the range of the display surface of the display unit 322.

The display unit 322 receives, through the communication module 310, image signals (hereinafter referred to as “first image signals”) sent by the electronic device 100, to display a picture according to the first image signals. The display unit 322 may be a display panel such as an Organic Light-Emitting Diode (OLED) or a Liquid-Crystal Display (LCD).

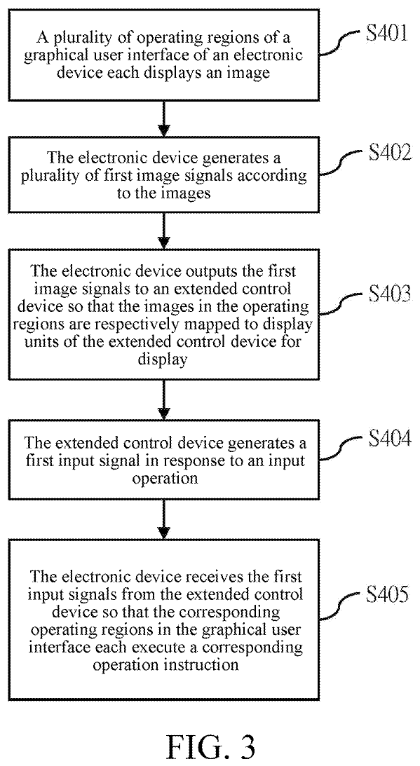

How the first image signals are generated is explained herein. FIG. 3 is a schematic flowchart of an image control method according to the first embodiment of the application. First, the plurality of operating regions 120a to 120d of the graphical user interface 110 of the electronic device 100 each displays an image (step S401). Next, in step S402, the electronic device 100 generates a plurality of first image signals according to the images. Then, the electronic device 100 outputs the first image signals to the extended control device 300 so that the images in the operating regions 120a to 120d are mapped to the plurality of display units 322 of the extended control device 300 for display (step S403).

Specifically, the electronic device 100 allows a user to set a pairing relationship between the operating regions 120 on the graphical user interface 110 and the input display modules 320. For example, an image in the operating region 120a is mapped to the display unit 322 of the input display module 320a for display; and an image in the operating region 120b is mapped to the display unit 322 of the input display module 320b for display. The electronic device 100 may capture an image in each operating region 120, encode the captured images into the first image signals, and send the first image signals respectively to the corresponding processors 330 of the extended control device 300 according to the preset pairing relationship. The image capture may be performed once, multiple times, or continuously. The processors 330, after receiving the first image signals, decode the first image signals to control the display units 322 to display images. Therefore, the images in the operating regions 120a to 120d on the graphical user interface 110 are displayed respectively on the display units 322 corresponding to the input display modules 320a to 320d.

In some embodiments, the pixel size and shape of the operating region 120 may be different from the resolution and shape of the display unit 322. Therefore, image processing, such as scaling up, scaling down, or cropping, needs to be performed on the image in the operating region 120, to conform to the resolution and shape of the display unit 322. The image processing may be performed by the electronic device 100 or the processors 330. This is not limited in the application.

In some embodiments, the display unit 322 is connected to the processor 330 through a Mobile Industry Processor Interface (MIPI).

Next, how the electronic device 100 operates according to the first input signals generated by the input units 321 is explained. First, the extended control device 300 generates a first input signal in response to an input operation (step S404). The electronic device 100 receives the first input signal from the extended control device 300 so that the corresponding operating region 120 of the graphical user interface 110 executes a corresponding operation instruction (step S405). That is, through the foregoing paring relationship between the operating regions 120 and the input display modules 320, an input operation of the input unit 321 of the input display module 320a generates a first input signal, and the operating region 120a executes a corresponding operation instruction according to the first input signal; an input operation of the input unit 321 of the input display module 320b generates a first input signal, and the operating region 120b executes a corresponding operation instruction according to the first input signal. Specifically, when the input operation is a keystroke operation of the switch 3211, the processors 330 transmit an input signal representing that the switch 3211 is stroked to the electronic device 100 through the communication module 310. According to the pairing relationship between the operating regions 120 and the input display modules 320, the electronic device 100 converts the first input signal into a click operation instruction in the corresponding operating region 120. For example, the graphical user interface 110 includes a virtual button located in the operating region 120. Then, the application executes, according to the click operation instruction, a feedback action for the click on the virtual button (for example, making a character in the game jump). Therefore, keystroke operations on different input display modules 320 of the user are equivalent to click operations on the corresponding operating regions 120 of the graphical user interface 110. Similarly, when the input operation is a touch operation on the touch panel 3212, the processors 330 transmit an input signal including touch information to the electronic device 100 through the communication module 310. According to the pairing relationship between the operating regions 120 and the input display modules 320, the electronic device 100 converts the first input signal into a touch operation instruction in the corresponding operating region 120. Therefore, a touch track of the user on the touch panel 3212 of the input display module 320 is converted into a touch track in the corresponding operating region 120, so that the application may perform a corresponding feedback action, for example, performing a slider operation to adjust the volume. Furthermore, if the touch operation is a click operation, the application may also execute the foregoing action of clicking the virtual button, depending on the feedback action defined by the application for the touch operation in the operating region 120.

Touch coordinates of the touch panel 3212 are inconsistent with touch coordinates mapped into the operating region 120. Therefore, coordinate conversion needs to be performed on the touch information. The coordinate conversion may be performed by the electronic device 100 or the processors 330. This is not limited in the application.

In some embodiments, the touch panel 3212 is connected to the processors 330 through an Inter-Integrated Circuit (I²C).

In some embodiments, the switch 3211 is connected to the processors 330 through a General-Purpose Input/Output (GPIO).

In some embodiments, steps S404 to S405 may be performed before steps S402 to S404, or performed simultaneously in a multi-threaded manner.

According to the description above, the user may see, on the display units 322 of the input display modules 320, the images of the corresponding operating regions 120, thereby performing input operations on the input display modules 320, which is intuitive in use and can reduce burden on the user.

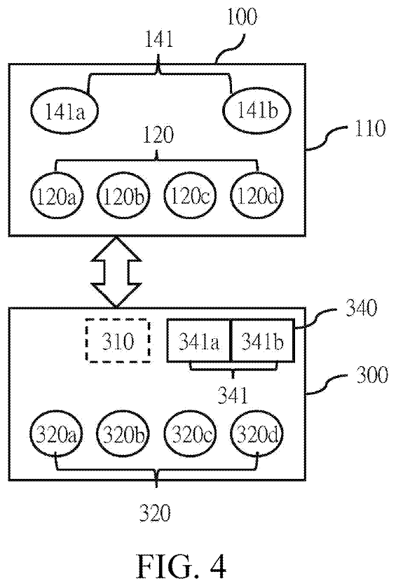

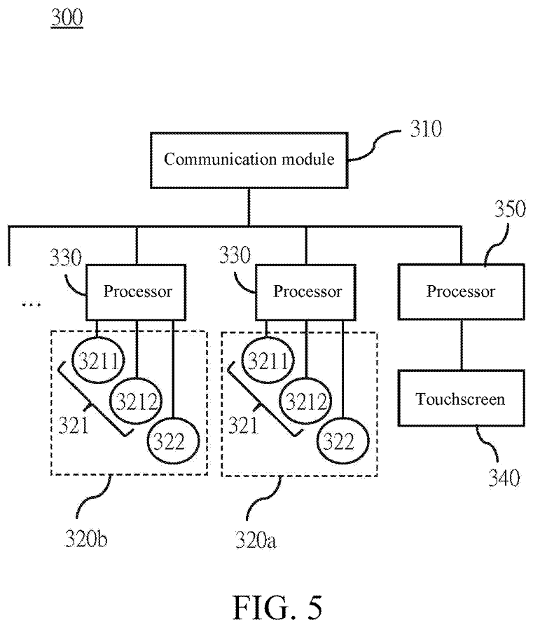

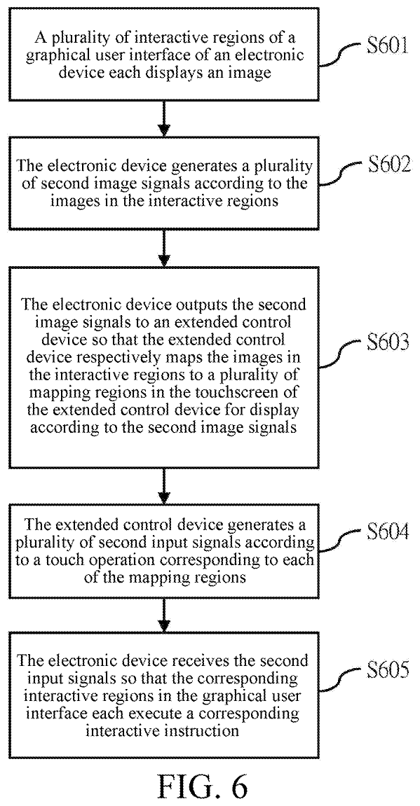

Referring to FIG. 4 to FIG. 6 together, FIG. 4 is a schematic structural diagram of an extended control device 300 according to a second embodiment of the application; FIG. 5 is a circuit block diagram of the extended control device 300 according to the second embodiment of the application; and FIG. 6 is a schematic flowchart of an image control method according to the second embodiment of the application. The difference from the first embodiment is that the extended control device 300 according to the second embodiment of the application may further include a touchscreen 340 and a processor 350. The processor 350 is connected between the communication module 310 and the touchscreen 340. Different from the foregoing one-to-one pairing relationship between the operating regions 120 and the input display modules 320, the touchscreen 340 may be paired with a plurality of interactive regions 141 of the graphical user interface 110 by the user through customization. The touchscreen 340 is divided into a plurality of mapping regions 341 (two mapping regions 341a and 341b are taken as an example herein). The user may operate to set the one-to-one pairing relationship between the mapping regions 341 and a plurality of interactive regions 141 (two interactive regions 141a and 141b are taken as an example herein) of the graphical user interface 110. Similar to the first embodiment, according to the pairing relationship, the displayed images of the mapping regions 341 and the input operations of the corresponding interactive regions 141 correspond to each other. The image control method according to this embodiment further includes steps S601 to S605. First, the plurality of interactive regions 141 of the graphical user interface 110 each displays an image (step S601). Next, the electronic device 100 generates second image signals according to the images in the interactive regions 141 (step S602). In step S603, the electronic device 100 outputs the second image signals to the extended control device 300 so that the extended control device 300 respectively maps the images in the interactive regions 141 to the corresponding mapping regions 341 of the touchscreen 340 of the extended control device 300 for display according to the second image signals. In step S604, the extended control device 300 generates a plurality of second input signals according to a touch operation respectively corresponding to the mapping regions 341. The electronic device 100 receives the second input signals so that the corresponding interactive regions 141 of the graphical user interface 110 execute a corresponding interactive instruction (step S605). Refer to the description of the first embodiment for details, which are not repeated here.

In some embodiments, steps S604 to S605 may be performed before steps S602 to S604, or performed simultaneously in a multi-threaded manner.

In some embodiments, the touchscreen 340 is connected to the processor 350 through a Mobile Industry Processor Interface (MIPI). In some embodiments, the touchscreen 340 is connected to the processor 350 through an inter-integrated circuit.

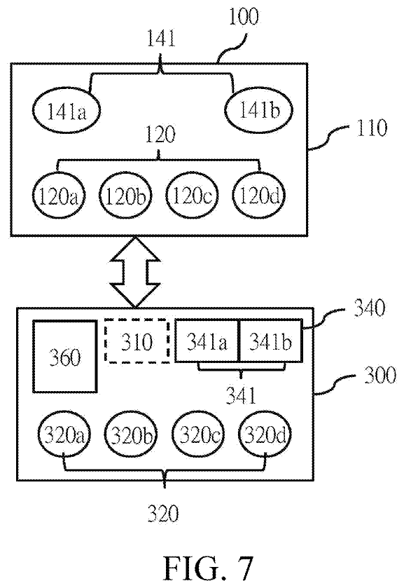

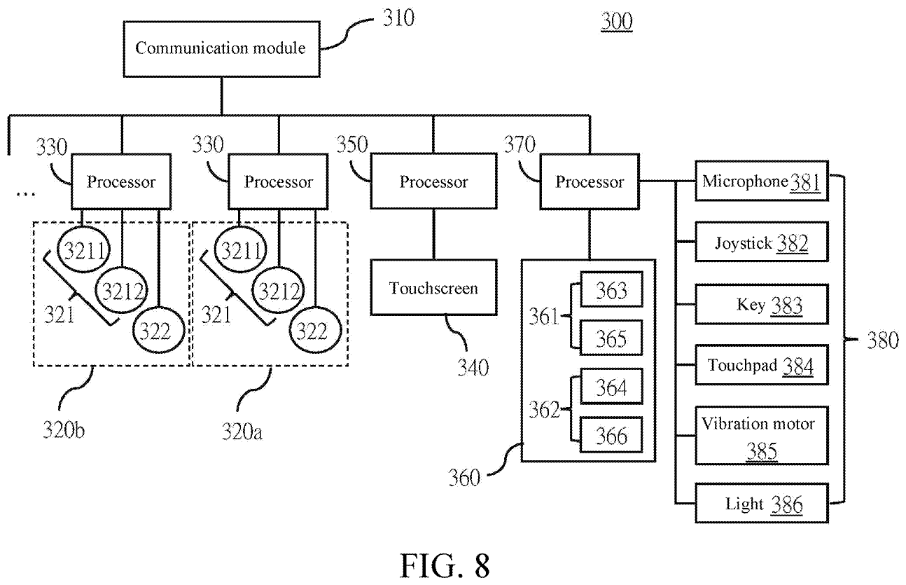

Referring to FIG. 7 and FIG. 8 together, FIG. 7 is a schematic structural diagram of an extended control device 300 according to a third embodiment of the application; FIG. 8 is a circuit block diagram of the extended control device 300 according to the third embodiment of the application. The difference from the foregoing embodiments is that the extended control device 300 according to the third embodiment of the application may further include a 3D motion detection module 360 and a processor 370. The processor 370 is connected between the communication module 310 and the 3D motion detection module 360. The 3D motion detection module 360 includes a plane sensing unit 361 and a distance sensing unit 362.

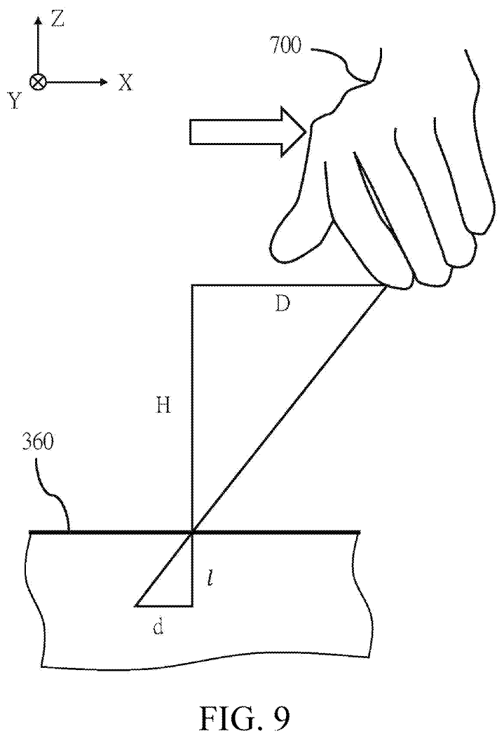

FIG. 9 is a schematic diagram of measurement by the 3D motion detection module 360 according to the third embodiment of the application. In a 3D coordinate system, the plane sensing unit 361 is configured to sense a plane coordinate displacement of a dynamic object 700 (taking a palm as an example here) on the X-Y plane. The distance sensing unit 362 is configured to sense a vertical distance of the dynamic object 700 on the Z axis. The processor 370 can calculate a plane movement distance D of the dynamic object 700 according to a vertical distance H and a plane coordinate displacement d. Specifically, the plane movement distance D is calculated according to Equation 1. A focal length/is a focal length of the plane sensing unit 361. The processor 370 may combine the calculated plane movement distance D with a change in the vertical distance H of the dynamic object 700 (that is, the vertical movement distance) to obtain 3D movement information of the dynamic object 700. Accordingly, the application may execute a corresponding feedback action according to the 3D movement information.

$$Plane movement distance D = \frac{vertical distance H}{focal length l} \times plane coordinate displacement d \qquad ( Equation 1 )$$

Specifically, the plane sensing unit 361 includes an infrared sensor 363 and an image sensor 365. The foregoing focal length/refers to a focal length of the image sensor 365. The infrared sensor 363 is configured to detect the presence of the dynamic object 700. The infrared sensor 363 may be a pyroelectric sensor or a quantum sensor, to detect the presence of the dynamic object 700 by sensing heat or light. The image sensor 365 is configured to capture a plurality of images sequentially (or referred to as sequential images) of the dynamic object 700. The processor 370 may recognize a feature corresponding to the dynamic object 700 in the sequential images, and obtain the plane coordinate displacement d according to a displacement of the feature. Specific process is described hereinafter. The distance sensing unit 362 includes a sonar sensor 364 and a proximity sensor 366. The sonar sensor 364 is configured to sense a spacing distance relative to the dynamic object 700. The proximity sensor 366 includes an effective detection range for determining that the dynamic object 700 exists in the effective detection range. There are a minimum value and a maximum value of a detection range on the Z axis, and the effective detection range is between the maximum value and minimum value. When the processor 370 detects that the dynamic object 700 exists in the effective detection range through the proximity sensor 366, the vertical distance H can be obtained according to the spacing distance obtained by the sonar sensor 364. Therefore, the sonar sensor 364 and the proximity sensor 366 double confirm that the detection result is correct. In some embodiments, the sonar sensor 364 and the proximity sensor 366 may be used simultaneously. In some embodiments, to reduce energy consumption, the proximity sensor 366 may be used first, and the sonar sensor 364 is activated only when it is detected that the dynamic object 700 exists in the effective detection range.

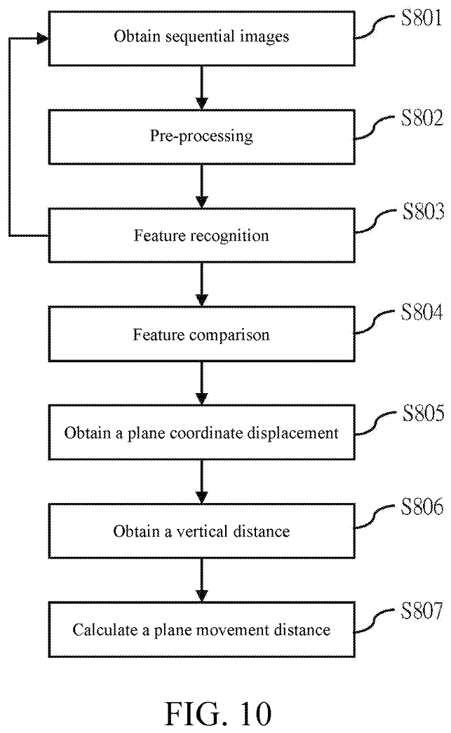

FIG. 10 is a schematic flowchart of 3D motion detection according to the third embodiment of the application, which is executed by the processor 370. First, the foregoing sequential images are obtained (step S801). Next, the sequential images are pre-processed (for example, dividing the sequential images into a plurality of grids) to facilitate subsequent feature detection (step S802). In step S803, feature recognition is performed on the dynamic object 700 in the sequential images, where the feature may be, for example, a corner feature. After the foregoing steps S801 to S803 are performed on each sequential image, a displacement of the corresponding feature in successive sequential images may be obtained through comparison (step S804), thereby obtaining the plane coordinate displacement d (step S805). Moreover, the vertical distance H is obtained from the sonar sensor 364 (step S806). Then, the plane movement distance D of the dynamic object 700 can be calculated according to Equation 1 (step S807).

In some embodiments, step S806 is not necessarily after step S805, but may be performed before step S805.

In some embodiments, the infrared sensor 363 is a thermal imager. The processor 370 may use obtained thermal images as the sequential images, and perform the foregoing steps S801 to S805, thereby obtaining another plane coordinate displacement d and double confirming the foregoing plane coordinate displacement d obtained according to the sequential images of the image sensor 365.

Referring to FIG. 8, the extended control device 300 may further include one or more peripheral devices 380 connected to the processor 370. The peripheral device 380 may include a microphone 381, a joystick 382, a key 383, a touchpad 384, a vibration motor 385, and a light 386. The microphone 381 is configured to receive voice of the user to perform voice input. The joystick 382, the key 383, and the touchpad 384 are provided as input interfaces for other channels. The vibration motor 385 can provide a vibration somatosensory function. The light 386 may be, for example, a light bar, for changing the intensity, dimming, and color of the light in coordination with the application.

To sum up, compared with existing electronic games, the extended control device and image control method according to the embodiments of the application provide diverse and intuitive operations to improve usage experience and reduce operation difficulty for a user. Furthermore, each of a plurality of processors is used for managing a part of hardware respectively, so that lower-level processors may be selected, thereby reducing costs and energy consumption.

What is claimed is:

1. An extended control device, suitable for cooperating with an electronic device, wherein the electronic device is provided with a graphical user interface, and the graphical user interface comprises a plurality of operating regions, the extended control device comprising:
a communication module, communicatively connected to the electronic device to receive a plurality of first image signals generated according to images in the operating regions of the graphical user interface; and
a plurality of input display modules, wherein each of the input display modules comprises an input unit and a display unit, the input units generate a plurality of first input signals respectively in response to an input operation; the plurality of first input signals are transmitted to the electronic device through the communication module, the operating regions of the graphical user interface execute operation instructions correspondingly according to the first input signals, and the images in the operating regions are mapped to the display units for display according to the first image signals.

2. The extended control device according to claim 1, wherein each of the input units comprises a touch panel disposed corresponding to a display surface of the display unit, and the input operation is a touch operation.

3. The extended control device according to claim 1, wherein each of the input units comprises a switch, and the input operation is a keystroke operation.

4. The extended control device according to claim 1, wherein the graphical user interface further comprises a plurality of interactive regions, the electronic device further generates second image signals according to images in the interactive regions, the extended control device further comprises a touchscreen, the touchscreen is divided into a plurality of mapping regions and generates a plurality of second input signals respectively in response to a touch operation corresponding to the mapping regions, the interactive regions of the graphical user interface of the electronic device execute interactive instructions correspondingly according to the second input signals; and the extended control device respectively maps the images in the interactive regions to the mapping regions for display according to the second image signals.

5. The extended control device according to claim 4, further comprising a processor, wherein the processor is connected between the communication module and the touchscreen.

6. The extended control device according to claim 1, further comprising a plurality of processors, wherein one end of each of the processors is connected to the communication module, and another end of each of the processors is connected to each of the input display modules in a one-to-one manner to control the input units and the display units of the connected input display modules.

7. The extended control device according to claim 1, further comprising a 3D motion detection module and a processor, wherein the 3D motion detection module comprises:
a plane sensing unit, configured to sense a plane coordinate displacement of a dynamic object; and
a distance sensing unit, configured to sense a vertical distance relative to the dynamic object;
wherein the processor calculates a plane movement distance of the dynamic object according to the vertical distance and the plane coordinate displacement, and to obtain 3D movement information of the dynamic object with reference to a change in the vertical distance of the dynamic object.

8. The extended control device according to claim 7, wherein the plane sensing unit comprises:
an infrared sensor, configured to detect the presence of the dynamic object; and
an image sensor, configured to capture a plurality of sequential images of the dynamic object;
wherein the processor recognizes a feature corresponding to the dynamic object in the sequential images, and obtains the plane coordinate displacement according to a displacement of the feature.

9. The extended control device according to claim 7, wherein the distance sensing unit comprises:
a sonar sensor, configured to sense a spacing distance relative to the dynamic object; and
a proximity sensor, comprising an effective detection range for determining whether the dynamic object exists in the effective detection range;
wherein the processor obtains the vertical distance according to the spacing distance when the dynamic object exists in the effective detection range.

10. The extended control device according to claim 1, further comprising a peripheral device, wherein the peripheral device is a microphone, a joystick, a key, a touchpad, a vibration motor or a light.

11. An image control method, comprising:
displaying an image in each of a plurality of operating regions of a graphical user interface of an electronic device respectively;
generating, by the electronic device, a plurality of first image signals according to the images;
outputting, by the electronic device, the first image signals to an extended control device so that the images in the operating regions are respectively mapped to a plurality of display units of the extended control device for display;
generating, by a plurality of input units of the extended control device, a plurality of first input signals respectively in response to an input operation; and
receiving, by the electronic device, the first input signal from the extended control device so that the operating regions of the graphical user interface executes operation instructions correspondingly.

12. The image control method according to claim 11, wherein each of the input units comprises a touch panel disposed corresponding to a display surface of the display unit, and the input operation is a touch operation.

13. The image control method according to claim 11, wherein each of the input units comprises a switch, and the input operation is a keystroke operation.

14. The image control method according to claim 11, further comprising:
generating, by the electronic device, a plurality of second image signals according to images in a plurality of interactive regions;
outputting, by the electronic device, the second image signals to the extended control device so that the extended control device respectively maps the images in the interactive regions to a plurality of mapping regions in a touchscreen of the extended control device for display according to the second image signals;
generating, by the extended control device, a plurality of second input signals according to a touch operation respectively corresponding to the mapping regions; and
receiving, by the electronic device, the second input signals so that the interactive regions of the graphical user interface execute interactive instructions correspondingly.
